(19) United States
(12) Patent Application Publication
(10) Pub. No.: US 2025/0036995 A1
(43) Pub. Date: Jan. 30, 2025

(54) QUANTUM CIRCUIT DESIGN METHOD FOR SHA3-256 HASH FUNCTION ALGORITHM AND QUANTUM CIRCUIT DESIGNED USING THE SAME

(71) Applicant: ELECTRONICS AND TELECOMMUNICATIONS RESEARCH INSTITUTE, Daejeon (KR)

(72) Inventor: Jong-Heon LEE, Seoul (KR)

(21) Appl. No.: 18/604,596

(22) Filed: Mar. 14, 2024

(30) Foreign Application Priority Data
Jun. 7, 2023 (KR) 10-2023-0072845

(51) Int. Cl. G06N 10/40; G06N 10/20

(52) U.S. Cl. CPC G06N 10/40; G06N 10/20

(57) ABSTRACT

Disclosed herein are a method for quantum circuit design for a SHA3-256 hash function algorithm and a quantum circuit designed using the method. The method includes inputting respective index values of five types of function blocks constituting the SHA3-256 hash function algorithm to data qubits, forming a chi function quantum circuit, among the five types of function blocks, using a Mixed Polarity Toffoli (MPT) gate, and designing a SHA3-256 quantum circuit based on an in-place version of a quantum circuit for each of the five types of function blocks, including the chi function quantum circuit.

### CROSS REFERENCE TO RELATED APPLICATION

This application claims the benefit of Korean Patent Application No. 10-2023-0072845, filed Jun. 7, 2023, which is hereby incorporated by reference in its entirety into this application.

### BACKGROUND OF THE INVENTION

### 1. Technical Field

The present disclosure relates generally to quantum circuit design technology for a SHA3-256 hash function algorithm, and more particularly to technology for quantum circuit implementation depending on an increase or decrease in a Toffoli-depth, a Toffoli-count, and the number of qubits, which are cost metrics (cost functions) for determining the execution time and design cost of a circuit.

### 2. Description of Related Art

Existing SHA3-256 quantum circuits tend to use excessive amounts of quantum resources because they are designed to use many ancilla (work) qubits. Such a structure results in incidental production of many garbage qubits, which are difficult to be reused in a subsequent operation within the quantum circuit, and initializing the garbage qubits such that they can be used in the subsequent operation causes a problem of having to add more gates in the quantum circuit.

### DOCUMENTS OF RELATED ART

(Patent Document 1) Korean Patent Application Publication No. 10-2019-0007375, published on Jan. 22, 2019 and titled “Quantum circuit for phase shift of target qubit based on control qubit”.

### SUMMARY OF THE INVENTION

An object of the present disclosure is to implement an efficient SHA3-256 quantum circuit that has a short execution time and prevents excessive usage of quantum resources such as ancilla qubits and the like.

Another object of the present disclosure is to provide a method for designing an in-place version of a quantum circuit for a SHA3-256 hash function algorithm, thereby more efficiently using ancilla qubits in the quantum circuit.

In order to accomplish the above objects, a method for quantum circuit design for a SHA3-256 hash function algorithm according to the present disclosure includes inputting respective index values of five types of function blocks constituting the SHA3-256 hash function algorithm to data qubits, forming a chi function quantum circuit, among the five types of function blocks, using a Mixed Polarity Toffoli (MPT) gate, and designing a SHA3-256 quantum circuit based on an in-place version of a quantum circuit for each of the five types of function blocks, including the chi function quantum circuit.

Here, in a quantum circuit system including the SHA3-256 quantum circuit, an initialized ancilla qubit may be provided for an operation arranged after the SHA3-256 quantum circuit.

Here, the chi function quantum circuit may be classified into four types having different levels of time efficiency and space efficiency depending on components, and the SHA3-256 quantum circuit may include a chi function quantum circuit corresponding to one of the four types.

Here. a first-type chi function quantum circuit, among the four types, may be designed using seven MPT gates, and no ancilla qubits may be used therein.

Here, the first-type chi function quantum circuit may have multiple forms depending on whether positions of the gates are swapped.

Here, a second-type chi function quantum circuit, among the four types, may be designed using seven MPT gates, four CNOT gates, and two initialized ancilla qubits.

Here, a third-type chi function quantum circuit, among the four types, may be designed using 20 MPT gates, 30 CNOT gates, and 10 initialized ancilla qubits.

Here, a fourth-type chi function quantum circuit, among the four types, may be designed using 20 MPT gates, 30 CNOT gates, and 10 initialized ancilla qubits, and the 20 MPT gates included in a chi function quantum circuit of a Measurement-Based Quantum Computation (MBQC) form, in which a measuring element is used in the middle of the circuit, may include five AND gates and five AND^{†} gates.

Here, the SHA3-256 quantum circuit may be designed so as not to include an inverse function quantum circuit for each of the five types of function blocks.

Also, a SHA3-256 quantum circuit according to an embodiment of the present disclosure includes an in-place version of a quantum circuit that implements an index value for each of five types of function blocks constituting a SHA3-256 hash function algorithm in a data qubit, and a chi function quantum circuit in the quantum circuit is formed using a Mixed Polarity Toffoli (MPT) gate.

Here, in a quantum circuit system including the SHA3-256 quantum circuit, an initialized ancilla qubit may be provided for an operation arranged after the SHA3-256 quantum circuit.

Here, the chi function quantum circuit may be classified into four types having different levels of time efficiency and space efficiency depending on components, and the SHA3-256 quantum circuit may include a chi function quantum circuit corresponding to one of the four types.

Here, a first-type chi function quantum circuit, among the four types, may be designed using seven MPT gates, and no ancilla qubits may be used therein.

Here, the first-type chi function quantum circuit may have multiple forms depending on whether positions of the gates are swapped.

Here, a second-type chi function quantum circuit, among the four types, may be designed using seven MPT gates, four CNOT gates, and two initialized ancilla qubits.

Here, a third-type chi function quantum circuit, among the four types, may be designed using 20 MPT gates, 30 CNOT gates, and 10 initialized ancilla qubits.

Here, a fourth-type chi function quantum circuit, among the four types, may be designed using 20 MPT gates, 30 CNOT gates, and 10 initialized ancilla qubits, and may correspond to a Measurement-Based Quantum Computation (MBQC) form in which a measuring element is used in the middle of the circuit.

Here, the 20 MPT gates included in the fourth-type chi function quantum circuit may include five AND gates and five AND^{†} gates.

Here, the SHA3-256 quantum circuit may be designed so as not to include an inverse function quantum circuit for each of the five types of function blocks.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating an example of a general sponge design structure;

FIG. 2 is a view illustrating an example of a set of NOT, CNOT, and Toffoli (NCT) gates;

FIG. 3 is a view illustrating an example of a mixed polarity Toffoli gate;

FIG. 4 is a view illustrating an example of an existing quantum circuit for a SHA3-256 hash function algorithm;

FIG. 5 is a flowchart illustrating a method for quantum circuit design for a SHA3-256 hash function algorithm according to an embodiment of the present disclosure;

FIG. 6 is a view illustrating an example of a quantum circuit for a SHA3-256 hash function algorithm that is designed according to the present disclosure;

FIGS. 7 and 8 are views illustrating examples of a first-type chi function quantum circuit according to the present disclosure;

FIG. 9 is a view illustrating an example of a second-type chi function quantum circuit according to the present disclosure;

FIG. 10 is a view illustrating an example of a third-type chi function quantum circuit according to the present disclosure;

FIG. 11 is a view illustrating an example of an AND gate;

FIG. 12 is a view illustrating an example of an AND^{†} gate; and

FIG. 13 is a view illustrating an example of a fourth-type chi function quantum circuit according to the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

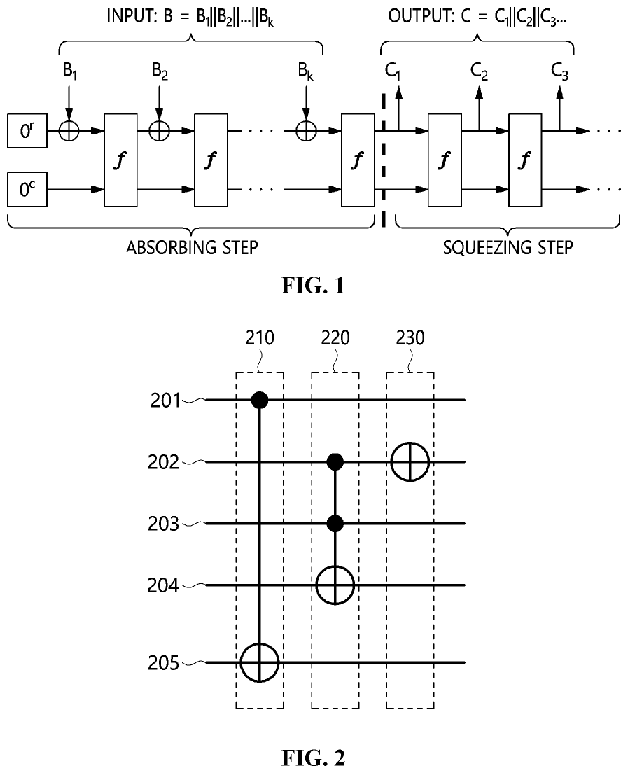

Hereinafter, existing technologies will be described in detail with reference to FIGS. 1 to 4.

FIG. 1 is a view illustrating an example of a general sponge design structure.

Referring to FIG. 1, all of the family functions of a SHA-3 function are designed to have a sponge structure such as that illustrated in FIG. 1, and all of the internal function blocks are configured as reversible functions. Here, the family functions are configured with a total of six function algorithms, and they have a difference only in parameter values.

The SHA3-256 hash function algorithm dealt with in the present disclosure is included in one of the family functions of the SHA-3 function, and it is configured with a total of five types of reversible function blocks.

The SHA3-256 hash function algorithm includes two steps. The first step is a preprocessing step, and a pad10*1 function for adding padding to a given message is used therein. The second step is an absorbing step for receiving the padded message, and a KECCAK-p permutation function is used therein.

Generally, the pad10*1 function and the KECCAK-p permutation function are used in a function algorithm having a sponge structure such as that illustrated in FIG. 1, and the entire function based on this structure is referred to as a KECCAK function, and may be represented as shown in Equation (1):

$$SHA 3 - 256 ( M ) = KECCAK [ 512 ] ( M ‖ 01 , 2 \; 56 ) \qquad ( 1 )$$

$$KECCAK [ c ] ( N , d ) = SPONGE ( KECCAK - p [ 1600 , 24 ] , pad 10 * 1 , 1600 - c )$$

Referring to Equation (1), it can be seen that a 256-bit hash value is output when message M is input to the SHA3-256 hash function algorithm. Here, two parameters, which correspond to c (capacity) and r (rate), are used in the SHA3-256 hash function algorithm.

Here, the length of parameter c is 512 bits, which is twice the length of the hash value (256 bits), and because the length of parameter r corresponds to 1600-c, it is 1088 bits in the SHA3-256 hash function algorithm.

As described above, the pad10*1 function is used in the preprocessing step. In the SHA3-256 hash function algorithm, message M to which padding is added through the pad10*1 function is divided into segments of 1088 bits each, whereby message blocks are generated. That is, the padded message may be generated to have a length of a multiple of 1088 bits in the preprocessing step.

First, when the length of message M is |M|, N=M∥01 is generated by adding the bitstring ‘01’ to the end of the message, and message blocks may be generated by adding the bitstring ‘100 . . . 001’ such that N has a length of a multiple of 1088 bits.

For example, assuming that |M|=487, |N|=489 may be satisfied, and the bitstring ‘100 . . . 001’ having the length of 599 bits is added such that its length becomes a multiple of 1088 bits, whereby one message block may be generated. That is, when the length of message M satisfies ‘1086 bits<|M|≤1088 bits’, two message blocks, each having the length of 1088 bits, may be generated. When two message blocks are generated as described above, the KECCAK-p [1600,24] function used in the absorbing step, which is performed after the preprocessing step, may be called twice.

Hereinafter, a description will be made on the assumption that one message block is present for convenience of the description. That is, it is assumed that ‘|M|<1087’ is satisfied.

In the absorbing step, the KECCAK-p [1600,24] function such as that shown in Equation (1) is used, and the information of the padded message block is absorbed in this step.

For example, function ƒ illustrated in FIG. 1 indicates the KECCAK-p [1600,24] function, and referring to the absorbing step illustrated in FIG. 1, it can be seen that k message blocks corresponding to the length of r bits are sequentially absorbed. Here, all of the input and output values of the function ƒ have the length of (r+c) bits.

Here, the SHA3-256 hash function algorithm dealt with in the present disclosure does not include the squeezing step illustrated in FIG. 1. That is, C₁, which is the output value of the absorbing step illustrated in FIG. 1, may correspond to the 256-bit hash value, which is the output value of the SHA3-256 hash function algorithm.

In the SHA3-256 hash function algorithm, the length of parameter r is 1088 bits, and the length of parameter c is 512 bits, as described above. That is, when the absorbing step of the SHA3-256 hash function algorithm commences, a 512-bit bitstring ‘0 . . . 0’ is added to the end of the 1088-bit message block. When there are two or more message blocks, an exclusive-OR (XOR) operation with the first 1088 bits of the result value of the first KECCAK-p [1600,24] function is performed, and the result thereof may be input to the second KECCAK-p [1600,24] function.

Here, in the KECCAK-p [1600,24] function, a round function ‘Rnd’ is iterated a total of 24 times, as shown in Equation (2), and the Rnd function may be configured with five types of reversible functions (ι, χ, π, ρ, and θ).

| Input:state S(Array A) | |
|---|---|
| For iᵣ = 0 to 23 | |
| Rnd(A,iᵣ) = ι(χ(π(ρ(θ(A)))),iᵣ) | |
| Output:Trunc₂₅₆(S) | (2) |

Here, in the SHA3-256 hash function algorithm, a bitstring may be represented as state S, which uses one index, or array A, which uses three indices. When state S is used, the five reversible functions may be represented as shown in Equation (3).

$$θ : S [ 64 x + 320 y + 𝓏 ] ← S [ 64 x + 320 y + 𝓏 ] ⊕ ( {⊕}_{{y}^{′} ∈ {Z}_{5}} \{ S [ 64 ( x - 1 ) + 320 {y}^{′} + 𝓏 ] ⊕ S [ 64 ( x + 1 ) + 320 {y}^{′} + ( 𝓏 - 1 ) ] \} ) \qquad ( 3 )$$

$$ρ : S [ 63 x + 320 y + 𝓏 ] ← S [ 64 y + 320 ( 2 x + 3 y ) + 𝓏 - ( ( t + 1 ) ( t + 2 ) / 2 ) ]$$

$$started at ( x , y ) = ( 1 , 0 ) , 0 \leq t \leq 23$$

$$π : S [ 64 x + 320 y + 𝓏 ] ← S [ 64 ( x + 3 y ) + 320 x + 𝓏 ) ]$$

$$χ : S [ 64 x + 320 y + 𝓏 ] ← S [ 64 x + 320 y + 𝓏 ] ⊕ ( ( S [ 64 ( x + 1 ) + 3 \; 20 y + 𝓏 ] ⊕ 1 ) ∧ S [ 64 ( x + 2 ) + 320 y + 𝓏 ] )$$

$$ι ( {i}_{r} ) : S [ 𝓏 ] ← S [ 𝓏 ] ⊕ RC ( {i}_{r} ) [ 𝓏 ] \qquad 0 \leq {i}_{r} \leq 23$$

Here, because an operation in the Rnd function is generally performed using array A, conversion between state S and array A is required. The equation for conversion between state S and array A and the equations of the five types of reversible functions (ι, χ, π, ρ, and θ) represented using array A are as shown in Equation (4).

$$S [ 64 ( 5 y + x ) + 𝓏 ] = A [ x ] [ y ] [ 𝓏 ] , 0 \leq x , y < 5 , 0 \leq 𝓏 < 64 \qquad ( 4 )$$

$$θ : A [ x ] [ y ] [ 𝓏 ] = A [ x ] [ y ] [ 𝓏 ] ⊕ ( {⊕}_{y ' ∈ {Z}_{5}} \{ A [ x - 1 ] [ {y}^{′} ] [ 𝓏 ] ⊕ A [ x + 1 ] [ {y}^{′} ] [ 𝓏 - 1 ] \} )$$

$$ρ : A [ x ] [ y ] [ 𝓏 ] = A [ y ] [ 2 x + 3 y ] [ 𝓏 - ( ( t + 1 ) ( t + 2 ) / 2 ]$$

$$started at ( x , y ) = ( 1 , 0 ) , 0 \leq t \leq 23$$

$$π : A [ x ] [ y ] [ 𝓏 ] = A [ x + 3 y ] [ x ] [ 𝓏 ]$$

$$χ : A [ x ] [ y ] [ 𝓏 ] = A [ x ] [ y ] [ 𝓏 ] ⊕ ( ( A [ x + 1 ] [ y ] [ 𝓏 ] ⊕ 1 ∧ A [ x + 2 ] [ y ] [ 𝓏 ]$$

$$ι ( {i}_{r} ) : A [ 0 ] [ 0 ] [ 𝓏 ] = A [ 0 ] [ 0 ] [ 𝓏 ] ⊕ RC ( {i}_{r} ) [ 𝓏 ] \qquad 0 \leq {i}_{r} \leq 23$$

Here, in order to implement the SHA3-256 hash function algorithm as a quantum circuit, it is necessary to represent the function values in qubits, and qubits are generally arranged in the direction from top to bottom in the quantum circuit. That is, because it is reasonable to use state S, which is represented with a single index, as the index of the qubit, it is essential to convert the final hash value from array A to state S.

Here, because the theta (θ) function in Equation (4) is a linear reversible function, it may be designed as an in-place version of a quantum circuit using only CNOT gates, without the help of ancilla qubits.

Here, the ‘in-place version’ may mean that function values are represented in data qubits, rather than ancilla qubits, so all of the ancilla qubits are initialized after the function operation is finished. For reference, a method of representing function values in ancilla qubits is referred to as an out-of-place version. Therefore, when a quantum circuit is designed as an in-place version, ancilla qubits may be more effectively used for a subsequent operation.

Also, it can be seen that the operations of the rho (ρ) function and pi (π) function in Equation (4) can be implemented by merely swapping bits. That is, because it is only necessary to suitably change the positions of qubits in the quantum circuit, it may be determined that quantum circuit design cost for these two functions is not incurred at a logical level.

Also, the iota (ι) function in Equation (4) uses the constant vector RC, and the constant vector RC may be calculated in advance using an internal function rc. The iota (ι) function may be designed as a quantum circuit using only NOT gates.

The chi (χ) function in Equation (4) is a function that uses an AND operation, unlike the other functions, and may be designed using Toffoli gates corresponding to the AND operation in the quantum circuit. If a Fault-Tolerant Quantum Computing (FTQC) model is taken into account, T gates and T^{†} gates are used in the Toffoli gate, so this function is most costly to design and takes the longest time to execute.

In the quantum circuit designed as described above, bits containing information correspond to data qubits, and a part closer to the top of the quantum circuit corresponds to a Least Significant Bit (LSB), and a part closer to the bottom of the quantum circuit corresponds to a Most Significant Bit (MSB). Also, because the flow of time in a quantum circuit is from left to right, gates located on the left side of the quantum circuit may be executed first.

Here, quantum circuits are typically designed using a set of NOT, CNOT, and Toffoli (NCT) gates. The NCT gates may invert the state of a single qubit depending on a condition.

Referring to FIG. 2, a CNOT gate 210, a Toffoli gate 220, and a NOT gate 230 are illustrated from the left. For example, the CNOT gate 210 illustrated in FIG. 2 may invert the state of a qubit on a target line 205 when the state of a qubit on one control line 201 is TRUE (1), the Toffoli gate 220 may invert the state of a qubit on a target line 204 when all of the states of qubits on two control lines 202 and 203 are TRUE (1), and the NOT gate 230 may unconditionally invert the state of a qubit on a line 202 on which the gate is placed.

Here, using the NOT gate 230, it is possible to activate the Toffoli gate 220 in another condition, and such a gate is referred to as a mixed polarity Toffoli gate.

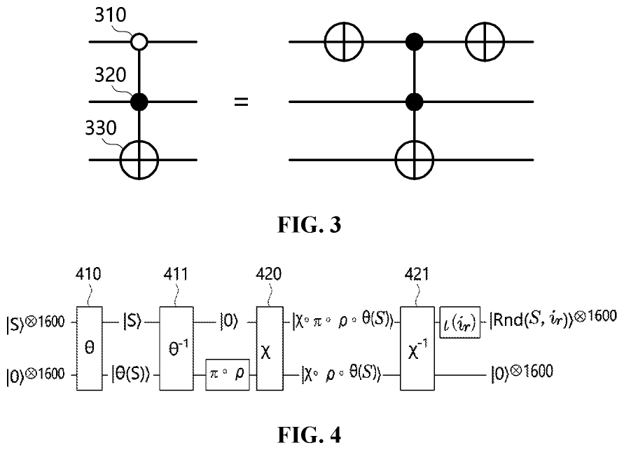

For example, the mixed polarity Toffoli gate illustrated in FIG. 3 inverts the state of a qubit 330 on the third control line corresponding to a target line when the state of a qubit 310 on the first control line, which corresponds to the LSB, is FALSE (0) and when the state of a qubit 320 on the second control line is TRUE (1).

Here, when a Toffoli gate is designed, a T gate and a T^{†} gate are used, and this causes the problems of higher design cost and longer execution time than other gates in the Fault-Tolerant Quantum Computing (FTQC) model. That is, in the FTQC model, a Toffoli-count, which is the number of T gates and T^{†} gates, and a Toffoli-depth, which is the depth formed by these gates in a quantum circuit (the number of times the T gate or the T^{†} gate is processed in a nonparallel manner in the quantum circuit), are very important cost metrics. Therefore, in order to reduce the cost when a quantum circuit is designed, it is required to decompose a Toffoli gate into basic gates in a Clifford+T gate set and reduce the Toffoli-count and the Toffoli-depth.

In the previous studies, techniques for efficiently designing a quantum circuit of the SHA3-256 hash function algorithm have been proposed. FIG. 4 illustrates quantum circuit design of the SHA3-256 hash function algorithm proposed in one of the previous studies.

Here, the quantum circuit illustrated in FIG. 4 corresponds to design in which the SHA3-256 hash function algorithm for one message block is executed when the quantum circuit is iterated a total of 24 times. In FIG. 4, it can be seen that 1600 initialized ancilla qubits are used and that inverse function quantum circuits 411 and 421 are respectively generated for the theta function quantum circuit 410 and the chi function quantum circuit 420. Here, because the theta function and the chi function are functions for which there is no need to generate inverse function circuits when a quantum circuit is designed, as described above, it can be seen that quantum resources are excessively used in the design illustrated in FIG. 4.

Also, the SHA3-256 hash function algorithm dealing with a bitstring configured with 1600 bits simultaneously processes 320 chi functions in parallel by grouping the 1600 bits into groups of 5 bits, as shown in Equation (4).

Using this characteristic, another study proposes a quantum circuit design method that uses only 320 initialized ancilla qubits, but it is designed to be five times longer than the depth of the circuit design illustrated in FIG. 4. This is because the 320 chi function blocks are divided into five groups of 64 chi function blocks and sequentially executed, and considering the entire temporal/spatial complexity of the circuit, this cannot be seen as a meaningful circuit design method.

Yet another study proposes a method of designing an out-of-place version of a quantum circuit in which function values are represented in initialized ancilla qubits. In this method, the total depth or the Toffoli-depth of the circuit is significantly reduced because initialized ancilla qubits are used, but a problem of producing many garbage qubits, which are difficult to be reused for the subsequent operation within the circuit, is caused. In order to use the uninitialized ancilla qubits in the subsequent operation, more gates should be added to the quantum circuit, so this cannot also be seen as a meaningful circuit design method.

Accordingly, the present disclosure proposes a method of designing an in-place version of a quantum circuit for the SHA3-256 hash function algorithm, which does not produce garbage qubits and does not require inverse function circuit design.

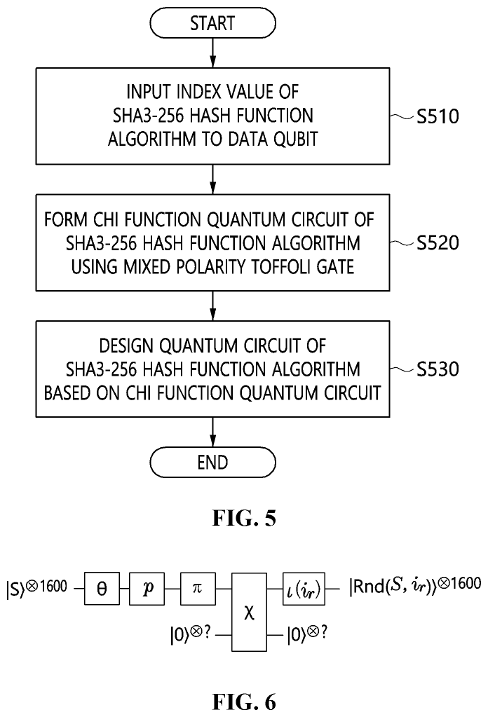

FIG. 5 is a flowchart illustrating a method for quantum circuit design for a SHA3-256 hash function algorithm according to an embodiment of the present disclosure.

Referring to FIG. 5, in the method for quantum circuit design for a SHA3-256 hash function algorithm according to an embodiment of the present disclosure, respective index values of five types of function blocks constituting the SHA3-256 hash function algorithm are input to data qubits at step S510.

Here, representing the index values of the function in the data qubits may correspond to an in-place version of the quantum circuit.

Here, the ‘in-place version’ may mean that function values are represented in data qubits, rather than ancilla qubits, so all of the ancilla qubits are initialized after the function operation is finished. For reference, a method of representing function values in ancilla qubits is referred to as an out-of-place version. Therefore, when a quantum circuit is designed as an in-place version, ancilla qubits may be more effectively used for a subsequent operation.

Also, in the method for quantum circuit design for a SHA3-256 hash function algorithm according to an embodiment of the present disclosure, a chi function quantum circuit, among the five types of function blocks, is formed using a Mixed Polarity Toffoli (MPT) gate at step S520.

Here, the chi function quantum circuit may be classified into four types having different levels of time efficiency and space efficiency depending on components.

Accordingly, the SHA3-256 quantum circuit designed according to the present disclosure may be formed by including one of the four types of the chi function quantum circuit.

Here, the first-type chi function quantum circuit, among the four types, may be designed using seven MPT gates, and no ancilla qubit may be used therein.

Here, the first-type chi function quantum circuit may have multiple forms depending on whether the positions of the gates are swapped.

Here, the second-type chi function quantum circuit, among the four types, may be designed using seven MPT gates, four CNOT gates, and two initialized ancilla qubits.

Here, the third-type chi function quantum circuit, among the four types, may be designed using 20 MPT gates, 30 CNOT gates, and 10 initialized ancilla qubits.

Here, the fourth-type chi function quantum circuit, among the four types, may be designed using 20 MPT gates, 30 CNOT gates, and 10 initialized ancilla qubits, and may correspond to a Measurement-Based Quantum Computation (MBQC) form in which a measuring element is used in the middle of the circuit.

Here, the 20 MPT gates included in the fourth-type chi function quantum circuit may include five AND gates and five AND^{†} gates.

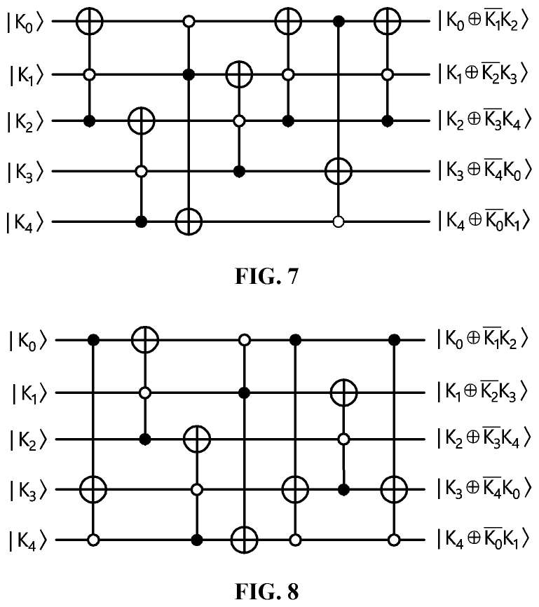

The four types of the chi function quantum circuit will be described in detail with reference to FIGS. 7 to 13.

Also, in the method for quantum circuit design for a SHA3-256 hash function algorithm according to an embodiment of the present disclosure, a SHA3-256 quantum circuit is designed based on the in-place version of the quantum circuit for each of the five types of function blocks, including the chi function quantum circuit, at step S530.

Here, in a quantum circuit system including the SHA3-256 quantum circuit, an initialized ancilla qubit may be provided for the operation arranged after the SHA3-256 quantum circuit.

Because all of the quantum circuit versions proposed in the present disclosure are in-place versions of circuits, all of the used ancilla qubits are initialized. Accordingly, the initialized ancilla qubits can be provided to the subsequent operation within the quantum circuit, whereby quantum resources may be more efficiently used.

For example, it may be assumed that the security of a SHA3-256 cryptosystem is determined in the Grover's algorithm, which is a representative quantum attack algorithm. Here, a mixed polarity multiple controlled Toffoli (MPMCT) gate may be arranged after the quantum circuit corresponding to the SHA3-256 cryptosystem, and when the MPMCT gate is designed, initialized ancilla qubits may be provided, whereby more efficient quantum circuit design may be realized.

Hereinafter, the four types of the chi function quantum circuit according to the present disclosure will be described in detail with reference to FIGS. 7 to 13.

First, the quantum circuit illustrated in FIG. 7 is the first-type chi function quantum circuit according to the present disclosure. Here, the first-type chi function quantum circuit is configured with seven MPT gates, and may correspond to a form in which no ancilla qubits are used.

Referring to FIG. 7, it can be seen that five types of position arrangement are present.

For example, it can be seen that the fourth and fifth gates from left have different activation conditions on the third control line from top. That is, the fourth gate is activated when the qubit placed on the third control line is FALSE (0), but the fifth gate is activated when the qubit placed on the third control line is TRUE (1), so the positions of the fourth and fifth gates may be swapped.

When the positions of the fourth and fifth gates are swapped, the third gate is adjacent to the fifth gate, in which case only one of them is activated depending on the state of the qubit placed on the second control line, so it is possible to swap their positions. In other words, it can be seen that two chi function quantum circuit versions other than the version illustrated in FIG. 7 are present.

Also, the chi function quantum circuit may be designed differently depending on the first gate arranged on the leftmost side of the quantum circuit.

For example, when the sixth gate in FIG. 7 is placed on the leftmost side, the chi function quantum circuit may be designed as illustrated in FIG. 8.

Here, because there are five different types of position arrangement depending on the gate placed on the leftmost side, it can be seen that the first-type chi function quantum circuit, which uses seven MPT gates and uses no ancilla qubits, has at least 15 different types.

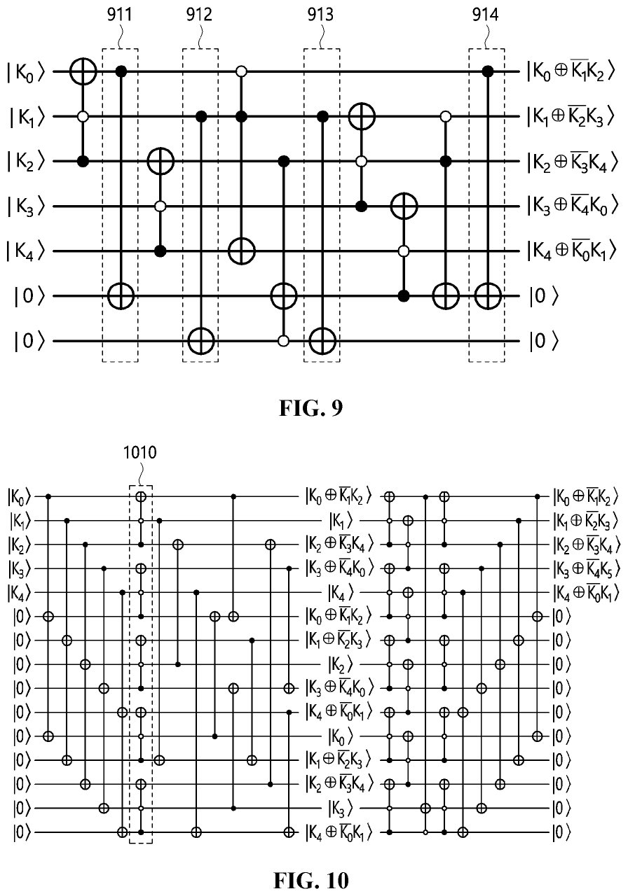

The quantum circuit illustrated in FIG. 9 is the second-type chi function quantum circuit according to the present disclosure. The second-type chi function quantum circuit is configured with seven MPT gates and four CNOT gates 911 to 914, and may correspond to a form in which two ancilla qubits are used.

Here, comparing the second-type chi function quantum circuit with the first-type chi function quantum circuit, it can be seen that the Toffoli-depth is reduced to 6 in the second-type chi function quantum circuit. That is, the Toffoli-count of the second-type chi function quantum circuit is 7 that is equal to the Toffoli-count of the first-type chi function quantum circuit, but the Toffoli-depth is reduced by 1, so a more time-efficient circuit may be configured in terms of the FTQC model. However, in the second-type chi function quantum circuit, the number of used ancilla qubits is increased compared to the first-type chi function quantum circuit, and CNOT gates are also added. Therefore, in terms of the design cost and the space efficiency, the first-type chi function quantum circuit may be more efficient than the second-type chi function quantum circuit.

The quantum circuit illustrated in FIG. 10 is the third-type chi function quantum circuit according to the present disclosure. The third-type chi function quantum circuit is configured with 20 MPT gates and 30 CNOT gates, and may correspond to a form in which 10 ancilla qubits are used.

Here, comparing the third-type chi function quantum circuit with the first-type chi function quantum circuit, it can be seen that the Toffoli-count is increased to 20, but the Toffoli-depth is reduced to 4. That is, referring to FIG. 10, it can be seen that the Toffoli-depth of 4 is realized through a mixed polarity Toffoli gate group 1010 formed by grouping five MPT gates.

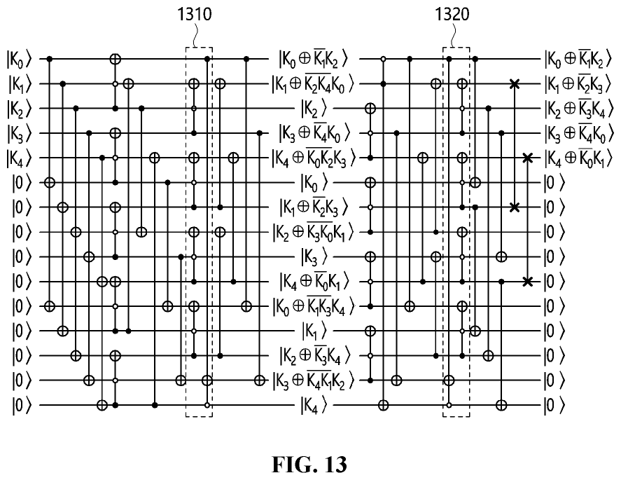

The quantum circuit illustrated in FIG. 13 is the fourth-type chi function quantum circuit according to the present disclosure. The fourth-type chi function quantum circuit uses 20 MPT gates and 10 ancilla qubits, like the third-type chi function quantum circuit, but it may correspond to a Measurement-based Quantum computation (MBQC) form in which a measuring element is used in the middle of the circuit.

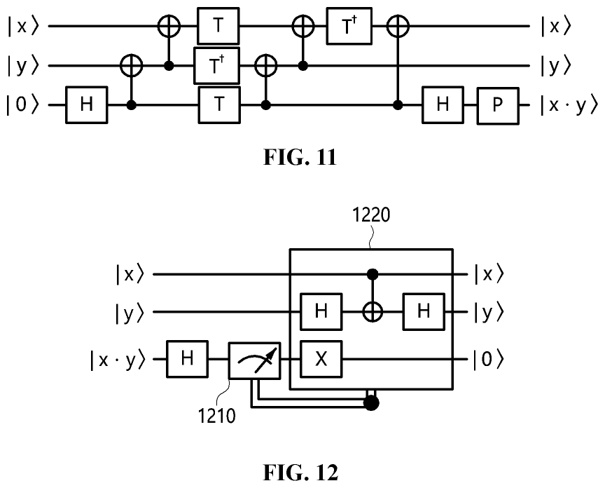

Before describing the fourth-type chi function quantum circuit, an AND gate and an AND^{†} gate will be described first with reference to FIG. 11 and FIG. 12.

The gate illustrated in FIG. 11 is an AND gate and the gate illustrated in FIG. 12 is an AND^{†} gate.

Here, the difference between a Toffoli gate and an AND gate is that the state of a qubit of a target part in the input value must be FALSE (0) in the AND gate. Also, in the AND^{†} gate, a measuring device 1210 is used, as illustrated in FIG. 12. For example, the AND^{†} gate may be configured such that whether specific gates 1220 are activated is determined depending on the result in the measuring device 1210. In FIG. 12, the measuring device 1210 is located after the H gate, and when the value measured by the measuring device 1210 is TRUE (1), the operations of the two H gates, the X gate, and the CNOT gate, corresponding to the specific gates 1220, may be performed. When the value measured by the measuring device 1210 is FALSE (0), the operations of the specific gates 1220 may not be performed. The form using the measuring device 1210 in the middle of the circuit corresponds to the fourth-type chi function quantum circuit illustrated in FIG. 13.

Accordingly, the fourth-type chi function quantum circuit illustrated in FIG. 13 may strictly correspond to a form in which ten MPT gates, five AND gates 1310, five AND^{†} gates 1320, and 30 CNOT gates are used.

Here, the last two gates in the quantum circuit illustrated in FIG. 13 are SWAP gates that merely change the positions of qubits, and incur no design cost at the logical level.

Here, the four internal function blocks, excluding the chi function described with reference to FIGS. 7 to 13, may be implemented as follows.

First, the theta (θ) function may be implemented with only a CNOT gate using a linear reversible circuit composition method.

Also, the rho (ρ) function and the pi (π) function may be implemented by merely changing the positions of qubits.

Also, the iota (ι) function may be implemented using only 86 NOT gates during a total of 24 rounds.

Here, the SHA3-256 quantum circuit designed according to an embodiment of the present disclosure may be designed so as not to include an inverse function quantum circuit for each of the five types of function blocks.

For example, FIG. 6 illustrates a quantum circuit for the SHA3-256 hash function algorithm designed according to the present disclosure. Here, according to the present disclosure, because a different number of ancilla qubits (|0>) is used for each type of the chi function quantum circuit used in the SHA3-256 quantum circuit, the number of ancilla qubits is represented as a question mark in FIG. 6.

Table 1 illustrates an example of quantum resources for the SHA3-256 quantum circuit that is designed by applying the four types of the chi function quantum circuit according to the present disclosure. In Table 1, SHA3-256-v1 may indicate the SHA3-256 quantum circuit applying the first-type chi function quantum circuit, SHA3-256-v2 may indicate the SHA3-256 quantum circuit applying the second-type chi function quantum circuit, SHA3-256-v3 may indicate the SHA3-256 quantum circuit applying the third-type chi function quantum circuit, and SHA3-256-v4 may indicate the SHA3-256 quantum circuit applying the fourth-type chi function quantum circuit.

TABLE 1

| | Width | Toffoli-count | Toffoli-depth | Remark |
|---|---|---|---|---|
| SHA3-256-v1 | 1600 | 53760 | 168 | In-place |
| SHA3-256-v2 | 2240 | 53760 | 144 | In-place |
| SHA3-256-v3 | 4800 | 153600 | 96 | In-place |
| SHA3-256-v4 | 4800 | 153600* | 96* | In-place |

Here, because SHA3-256-v1 uses the least number of qubits (Width) and has the smallest Toffoli-count, it may correspond to a circuit that can be designed at the lowest cost and is the most space-efficient circuit. Comparing SHA3-256-v2 with SHA3-256-v1, it can be seen that there is a trade-off relationship between the number of qubits and the Toffoli-depth. Both SHA3-256-v3 and SHA3-256-v4 have the Toffoli-depth of 96, and may correspond to the most time-efficient circuit.

However, because SHA3-256-v4 is a circuit using Measurement-based quantum computation (MBQC), performance in terms of time efficiency may vary depending on the efficiency of a measuring device in the middle of the circuit. For example, depending on the efficiency of the measuring device in the middle of the circuit, SHA3-256-v4 may have higher performance than SHA3-256-v3 in terms of time efficiency, or may have lower performance than SHA3-256-v3 in terms of time efficiency.

As described above, an efficient quantum circuit that uses less quantum resources than conventional known SHA3-256 quantum circuits may be designed through the method for quantum circuit design for a SHA3-256 hash function algorithm according to an embodiment of the present disclosure.

Also, because initialized ancilla qubits may be provided to a subsequent operation in the SHA3-256 quantum circuit by designing an in-place version, a more efficient SHA3-256 quantum circuit operation may be realized.

According to the present disclosure, an efficient SHA3-256 quantum circuit that has a short execution time and prevents excessive usage of quantum resources, such as ancilla qubits and the like, may be implemented.

Also, the present disclosure provides a method for designing an in-place version of a quantum circuit for a SHA3-256 hash function algorithm, thereby more efficiently using ancilla qubits in the quantum circuit.

As described above, the method for quantum circuit design for a SHA3-256 hash function algorithm and the quantum circuit designed using the method according to the present disclosure are not limitedly applied to the configurations and operations of the above-described embodiments, but all or some of the embodiments may be selectively combined and configured, so the embodiments may be modified in various ways.

What is claimed is:

1. A method for quantum circuit design for a SHA3-256 hash function algorithm, comprising:
inputting respective index values of five types of function blocks constituting the SHA3-256 hash function algorithm to data qubits;
forming a chi function quantum circuit, among the five types of function blocks, using a Mixed Polarity Toffoli (MPT) gate; and
designing a SHA3-256 quantum circuit based on an in-place version of a quantum circuit for each of the five types of function blocks, including the chi function quantum circuit.

2. The method of claim 1, wherein, in a quantum circuit system including the SHA3-256 quantum circuit, an initialized ancilla qubit is provided for an operation arranged after the SHA3-256 quantum circuit.

3. The method of claim 1, wherein the chi function quantum circuit is classified into four types having different levels of time efficiency and space efficiency depending on components, and the SHA3-256 quantum circuit includes a chi function quantum circuit corresponding to one of the four types.

4. The method of claim 3, wherein a first-type chi function quantum circuit, among the four types, is designed using seven MPT gates, and no ancilla qubits are used therein.

5. The method of claim 4, wherein the first-type chi function quantum circuit has multiple forms depending on whether positions of the gates are swapped.

6. The method of claim 3, wherein a second-type chi function quantum circuit, among the four types, is designed using seven MPT gates, four CNOT gates, and two initialized ancilla qubits.

7. The method of claim 3, wherein a third-type chi function quantum circuit, among the four types, is designed using 20 MPT gates, 30 CNOT gates, and 10 initialized ancilla qubits.

8. The method of claim 3, wherein a fourth-type chi function quantum circuit, among the four types, is designed using 20 MPT gates, 30 CNOT gates, and 10 initialized ancilla qubits, and corresponds to a Measurement-Based Quantum Computation (MBQC) form in which a measuring element is used in a middle of the circuit.

9. The method of claim 8, wherein the 20 MPT gates included in the fourth-type chi function quantum circuit include five AND gates and five AND^{†} gates.

10. The method of claim 1, wherein the SHA3-256 quantum circuit is designed so as not to include an inverse function quantum circuit for each of the five types of function blocks.

11. A SHA3-256 quantum circuit, comprising:
an in-place version of a quantum circuit that implements index values for each of five types of function blocks constituting a SHA3-256 hash function algorithm in data qubits,
wherein a chi function quantum circuit in the quantum circuit is formed using a Mixed Polarity Toffoli (MPT) gate.

12. The SHA3-256 quantum circuit of claim 11, wherein in a quantum circuit system including the SHA3-256 quantum circuit, an initialized ancilla qubit is provided for an operation arranged after the SHA3-256 quantum circuit.

13. The SHA3-256 quantum circuit of claim 11, wherein the chi function quantum circuit is classified into four types having different levels of time efficiency and space efficiency depending on components, and the SHA3-256 quantum circuit includes a chi function quantum circuit corresponding to one of the four types.

14. The SHA3-256 quantum circuit of claim 13, wherein a first-type chi function quantum circuit, among the four types, is designed using seven MPT gates, and no ancilla qubits are used therein.

15. The SHA3-256 quantum circuit of claim 14, wherein the first-type chi function quantum circuit has multiple forms depending on whether positions of the gates are swapped.

16. The SHA3-256 quantum circuit of claim 13, wherein a second-type chi function quantum circuit, among the four types, is designed using seven MPT gates, four CNOT gates, and two initialized ancilla qubits.

17. The SHA3-256 quantum circuit of claim 13, wherein a third-type chi function quantum circuit, among the four types, is designed using 20 MPT gates, 30 CNOT gates, and 10 initialized ancilla qubits.

18. The SHA3-256 quantum circuit of claim 13, wherein a fourth-type chi function quantum circuit, among the four types, is designed using 20 MPT gates, 30 CNOT gates, and 10 initialized ancilla qubits, and corresponds to a Measurement-Based Quantum Computation (MBQC) form in which a measuring element is used in a middle of the circuit.

19. The SHA3-256 quantum circuit of claim 18, wherein the 20 MPT gates included in the fourth-type chi function quantum circuit include five AND gates and five AND^{†} gates.

20. The SHA3-256 quantum circuit of claim 11, wherein the SHA3-256 quantum circuit is designed so as not to include an inverse function quantum circuit for each of the five types of function blocks.
